(19) United States
(12) Patent Application Publication
(10) Pub. No.: US 2026/0118155 A1
(43) Pub. Date: Apr. 30, 2026

(54) METHOD FOR ESTIMATING COMMERCIAL VEHICLE WEIGHT BASED ON DRIVING DATA AND APPARATUS THEREFOR

(71) Applicants: HYUNDAI MOTOR COMPANY, SEOUL (KR); KIA CORPORATION, SEOUL (KR)

(72) Inventor: Eun Chae Im, Hwaseong-si (KR)

(73) Assignees: HYUNDAI MOTOR COMPANY, SEOUL (KR); KIA CORPORATION, SEOUL (KR)

(21) Appl. No.: 19/249,186

(22) Filed: Jun. 25, 2025

(30) Foreign Application Priority Data
Oct. 29, 2024 (KR) 10-2024-0150080

(51) Int. Cl. G01G 19/08; G07C 5/04

(52) U.S. Cl. CPC G01G 19/086; G07C 5/04

(57) ABSTRACT

A method for estimating a commercial vehicle weight based on driving data and an apparatus therefor are provided. A computing device provided in a commercial vehicle includes a processor that executes instructions and a memory storing the instructions. The instructions are implemented to collect real-time vehicle driving data based on the ignition on state of the commercial vehicle, compare the real-time vehicle driving data with a certain launch acceleration trip condition to identify a launch acceleration trip interval, perform data preprocessing for the identified launch acceleration trip interval to generate an estimation dataset, and apply the estimation dataset to weight estimation calculation logic to estimate a weight corresponding to the identified launch acceleration trip interval.

### CROSS REFERENCE TO RELATED APPLICATIONS

This application claims the benefit of priority to Korean Patent Application No. 10-2024-0150080, filed in the Korean Intellectual Property Office on Oct. 29, 2024, the entire contents of which are incorporated herein by reference.

### TECHNICAL FIELD

The present disclosure relates to technologies for estimating a vehicle weight, and more particularly, relates to technologies for estimating a commercial vehicle weight based on driving data using a machine learning model.

### BACKGROUND

A commercial vehicle, such as a truck or a bus, has features which have a wide range of weight depending on the passengers and loading volume therein. If it is possible to perform accurate weight estimation for the commercial vehicle, this may be variously used in terms of vehicle control.

As an example, driving system torque and regenerative torque may be optimally controlled according to the weight of the commercial vehicle to improve efficiency. A brake system may be adjusted according to the weight of the commercial vehicle to minimize a braking distance, thus improving brake performance and ensuring stability. Furthermore, the wear and tear of a tire may be predicted using weight information of the commercial vehicle to predict an appropriate replacement time. A thermal management system may be optimized via optimal power electronic (PE)/battery thermal management system (BTMS) control according to the weight of the commercial vehicle.

In the related art, a sensor-based measurement method for measuring a weight of a vehicle using a sensor separately provided for weight measurement and a physical formula-based estimation method for estimating a weight based on a physical formula using a physical quantity generated while driving were roughly used.

However, the sensor-based measurement method has a limitation in terms of cost, because the separate sensor for weight measurement should be mounted on the vehicle. The physical formula-based estimation method has a problem in which it is impossible to mathematically perform accurate modeling for various resistance applied to the vehicle while driving.

As an example, the conventional physical formula-based estimation method has a problem in which an estimation error due to sensor noise is excessively large in certain situations, such as acceleration, deceleration, or gradient, because of using a measurement value of a longitudinal acceleration sensor and has a limitation in having an unstable initial estimation result depending on a parameter setting necessary for tuning even if using a state estimation algorithm or taking much time until the stabilized result value is estimated. As an example, a vehicle type, such as a city bus, has a problem wherein the frequency at which passengers ride or alight from the city bus is large and it is impossible to calculate a weight in the physical formula-based estimation method due to an acceleration/deceleration-oriented profile driving condition.

To overcome the limitations of the conventional vehicle weight measurement or estimation methods, research for applying various deep learning models has been performed. However, the research is limited in estimation accuracy because learning for a general deep learning model excludes a physical relationship between driving data and a vehicle weight, and is disadvantaged in that weight estimation performance is able to be considerably degraded for driving condition data which is not learned. Furthermore, model complexity is large as large-scale training data is required and there is a limitation in terms of embedding as a computing resource is excessively required.

### SUMMARY

The present disclosure has been made to solve the above-mentioned problems occurring in the prior art while advantages achieved by the prior art are maintained intact.

An aspect of the present disclosure provides a method for estimating a commercial vehicle weight based on driving data and an apparatus therefor.

Another aspect of the present disclosure provides a method for estimating a commercial vehicle weight based on driving data to generate a weight estimation model via derived variable learning capable of using commercial vehicle characteristics and specifying a physical relationship to minimize a computing resource and improve an inference speed and an apparatus therefor.

Another aspect of the present disclosure provides a method for estimating a commercial vehicle weight based on driving data to estimate the weight of the commercial vehicle via a machine learning model with small complexity and an apparatus therefor.

Another aspect of the present disclosure provides a weight estimation learning algorithm for applying a statistics-based training dataset using a derived variable capable of following a physical relationship and an associated characteristic between driving data and a weight to a model to provide a weight estimation model with larger reliability and an apparatus therefor.

Another aspect of the present disclosure provides a method for estimating a commercial vehicle weight based on driving data to reconstruct a multinomial linear regression equation for each derived variable based on a weight of a pre-trained model to estimate a weight and apply moving average for the estimated weight value to update a current weight and an apparatus therefor.

Another aspect of the present disclosure provides a vehicle weight-based driving and braking system for applying an estimated weight to control logic of a vehicle to ensure vehicle control robustness and reliability.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a computing device provided in a commercial vehicle may include a processor that executes instructions and a memory storing the instructions. The instructions may be implemented to collect real-time vehicle driving data based on that the commercial vehicle is ignition on, compare the real-time vehicle driving data with a certain launch acceleration trip condition to identify a launch acceleration trip interval, perform data preprocessing for the identified launch acceleration trip interval to generate an estimation dataset, and apply the estimation dataset to weight estimation calculation logic to estimate a weight corresponding to the identified launch acceleration trip interval.

As an embodiment, the processor may calculate a first-degree derived variable value based on the real-time vehicle driving data, may extract an average and quantile-based statistics numerical value based on the first-degree derived variable value, may calculate a second-degree derived variable value based on the statistics numerical value, and may generate the estimation dataset based on the second-degree derived variable value.

As an embodiment, a first-degree derived variable may be a variable capable of following a correlation between at least two physical quantities included in the real-time vehicle driving data and the weight.

As an embodiment, the processor may construct the weight estimation calculation logic based on a weight for each first-degree derived variable extracted from a pre-trained final weight estimation model.

As an embodiment, the processor may collect vehicle driving data for each weight corresponding to the commercial vehicle, may preprocess the vehicle driving data for each weight to generate a training dataset for each weight, may perform machine learning based on the training dataset for each weight to generate a weight estimation model, and may verify performance for the weight estimation model based on a previously constructed test dataset to determine the final weight estimation model.

As an embodiment, the processor may calculate a first-degree derived variable value for each weight based on the vehicle driving data for each weight, may extract an average and quantile-based statistics numerical value for each weight based on the first-degree derived variable value for each weight, may calculate a second-degree derived variable value for each weight based on the statistics numerical value for each weight, and may generate the training dataset for each weight based on at least one of the first-degree derived variable value for each weight or the second-degree derived variable value for each weight.

As an embodiment, the processor may perform a moving average of at least one weight previously estimated in a certain window interval and the estimated weight to update the estimated weight in response to the identified launch acceleration trip interval.

As an embodiment, the processor may provide a driving and braking system provided in the commercial vehicle with information about the updated weight.

As an embodiment, the real-time vehicle driving data may include at least one of wheel based speed data, lateral acceleration data, longitudinal acceleration data, yaw rate data, brake pedal position data, electric motor speed data, electric motor torque data, inverter current link data, inverter DC link voltage data, pinch angle data, or steering wheel angle data.

As an embodiment, a first-degree derived variable may include at least one of vehicle wheelbase speed-based acceleration Acc_cal, instant motor power Mot_pwr_kw, a vehicle speed*acceleration index VA_index, a torque/acceleration rate Rate_acc_tq, a VA index/power rate Rate_VA_pwr, an acceleration performance index VAP_Index, an acceleration efficiency index VAE_Index, or a driving efficiency index DE_Index.

According to another aspect of the present disclosure, a method for estimating a weight in a commercial vehicle may include collecting real-time vehicle driving data based on that the commercial vehicle is ignition on, comparing the real-time vehicle driving data with a certain launch acceleration trip condition to identify a launch acceleration trip interval, performing data preprocessing for the identified launch acceleration trip interval to generate an estimation dataset, and applying the estimation dataset to weight estimation calculation logic to estimate a weight corresponding to the identified launch acceleration trip interval.

As an embodiment, the performing of the data preprocessing to generate the estimation dataset may include calculating a first-degree derived variable value based on the real-time vehicle driving data, extracting an average and quantile-based statistics numerical value based on the first-degree derived variable value, and calculating a second-degree derived variable value based on the statistics numerical value. The estimation dataset may be generated based on the second-degree derived variable value.

As an embodiment, a first-degree derived variable may be a variable capable of following a correlation between at least two physical quantities included in the real-time vehicle driving data and the weight.

As an embodiment, the weight estimation calculation logic may be constructed based on a weight for each first-degree derived variable extracted from a pre-trained final weight estimation model.

As an embodiment, the final weight estimation model may be generated via a learning process including collecting vehicle driving data for each weight corresponding to a vehicle type of the commercial vehicle, preprocessing the vehicle driving data for each weight to generate a training dataset for each weight, performing machine learning based on the training dataset for each weight to generate a weight estimation model, and verifying performance for the weight estimation model based on a previously constructed test dataset to determine the final weight estimation model.

As an embodiment, the preprocessing of the vehicle driving data for each weight to generate the training dataset for each weight may include calculating a first-degree derived variable value for each weight based on the vehicle driving data for each weight, extracting an average and quantile-based statistics numerical value for each weight based on the first-degree derived variable value for each weight, and calculating a second-degree derived variable value for each weight based on the statistics numerical value for each weight. The training dataset for each weight may be generated based on at least one of the first-degree derived variable value for each weight or the second-degree derived variable value for each weight.

As an embodiment, the method may further include performing a moving average of at least one weight previously estimated in a certain window interval and the estimated weight to update the estimated weight in response to the identified launch acceleration trip interval.

As an embodiment, the method may further include transmitting information about the updated weight to a driving and braking system provided in the commercial vehicle.

As an embodiment, the real-time vehicle driving data may include at least one of wheel based speed data, lateral acceleration data, longitudinal acceleration data, yaw rate data, brake pedal position data, electric motor speed data, electric motor torque data, inverter current link data, inverter DC link voltage data, pinch angle data, or steering wheel angle data.

As an embodiment, a first-degree derived variable may include at least one of vehicle wheelbase speed-based acceleration Acc_cal, instant motor power Mot_pwr_kw, a vehicle speed*acceleration index VA_index, a torque/acceleration rate Rate_acc_tq, a VA index/power rate Rate_VA_pwr, an acceleration performance index VAP_Index, an acceleration efficiency index VAE_Index, or a driving efficiency index DE_Index.

### BRIEF DESCRIPTION OF THE FIGURES

The above and other objects, features and advantages of the present disclosure will be more apparent from the following detailed description taken in conjunction with the accompanying drawings:

FIG. 1 is a drawing for describing a configuration of a system for estimating a commercial vehicle weight according to an embodiment of the present disclosure;

FIG. 2 is a drawing for describing control flow for each entity in a system for estimating a commercial vehicle weight according to an embodiment of the present disclosure;

FIG. 3 is a block diagram for describing a configuration of a learning engine according to an embodiment of the present disclosure;

FIG. 4 is a block diagram for describing a detailed structure of a commercial vehicle according to an embodiment of the present disclosure;

FIG. 5 is a flowchart for describing a method for generating a model for weight estimation in a learning machine according to an embodiment of the present disclosure;

FIG. 6 is a flowchart for describing a preprocessing method in a learning machine according to an embodiment of the present disclosure;

FIG. 7 is a flowchart for describing a method for estimating a weight in a weight estimator according to an embodiment of the present disclosure;

FIG. 8 illustrates an example of applying a launch acceleration trip-based derived variable according to an embodiment of the present disclosure;

FIG. 9 illustrates an example of applying a derived variable based on statistics according to an embodiment of the present disclosure;

FIG. 10 is a table in which a derived variable and an operational formula thereof are defined;

FIG. 11 is a drawing for describing a method for extracting average/quantile data for each trip according to an embodiment of the present disclosure;

FIG. 12 is a drawing for describing a multinomial linear regression model which is a machine learning model according to an embodiment of the present disclosure; and

FIG. 13 illustrates a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

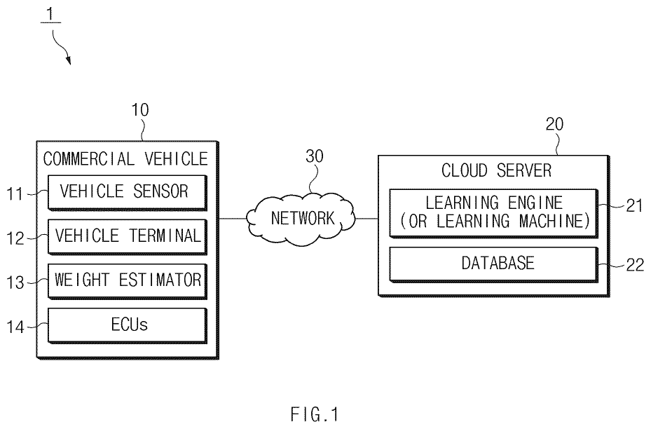

Hereinafter, embodiments of the present disclosure will be described in detail with reference to FIGS. 1 to 13.

FIG. 1 is a drawing for describing a configuration of a system for estimating a commercial vehicle weight according to an embodiment of the present disclosure.

Referring to FIG. 1, a system 1 for estimating a commercial vehicle weight may be roughly configured to include a commercial vehicle 10, a cloud server 20, and a network 30.

The network 30 may include a wired network including the Internet and a wireless network. As an example, the wireless network may include, but is not limited to, a commercial mobile communication network, such as 4G long term evolution (LTE), 5G new radio access network (NR), and may include a dedicated vehicle wireless communication network, such as dedicated short-range communication (DSRC), wireless access in vehicular environments (WAVE), and cellular vehicle to everything (C-V2X), a wireless-fidelity (Wi-Fi) network, and the like.

The commercial vehicle 10 may include a vehicle sensor 11, a vehicle terminal 12, a weight estimator 13, and electronic control units (ECUs) 14.

The cloud server 20 may be configured to include a learning engine (or a learning machine) 21 and a database 22.

Vehicle driving data previously collected for each weight may be maintained in the database 22.

The learning engine 21 may classify a launch acceleration trip for each weight based on the vehicle driving data for each weight, which is stored in the database 22, and may generate a first-degree derived variable for each weight for the classified launch acceleration trip for each weight. The learning engine 21 may calculate a first-degree derived variable value for each weight and may extract average/quantile-based statistics corresponding to the weight. The learning engine 21 may calculate a second-degree derived variable value based on the extracted statistics for each weight. The learning engine 21 may generate final training data, that is, a training dataset, based on the second-degree derived variable value for each weight, and may generate a weight estimation model via machine learning based on the generated training dataset. As an embodiment, the training dataset may be generated based on the first-degree derived variable value and the second-degree derived variable value.

A test dataset for verifying performance of the weight estimation model may be maintained in the database 22.

The learning engine 21 may obtain the test dataset from the database 22 and may apply the test dataset to the weight estimation model to verify current performance of the weight estimation model. If the performance of the weight estimation model does not meet a certain reference value, the learning engine 21 may fit the weight estimation model via parameter tuning to perform retraining, thus automatically updating the weight estimation model. The learning engine 21 may repeatedly perform parameter tuning and model fitting to perform training, until the performance of the weight estimation model meets the specific reference value, thus improving reliability and accuracy of the weight estimation model.

If the performance of the weight estimation model meets the certain reference value, the learning engine 21 may determine the weight estimation model as a final weight estimation model and may extract a weight for each derived variable based on the final weight estimation model.

The cloud server 20 may transmit information about the final weight estimation model and the extracted weight for each derived variable to the commercial vehicle 10 over the network 30.

As an example, the information about the final weight estimation model and the extracted weight for each derived variable may be transmitted to the commercial vehicle 10 via over-the-air (OTA).

The cloud server 20 according to an embodiment may generate a weight estimation model for each manufacturer and each vehicle type, may identify a manufacturer and a vehicle type for each target vehicle, and may transmit information about the final weight estimation model and the extracted weight for each derived variable, which is generated in response to the identified manufacturer and the identified vehicle type, to the target vehicle. As described above, the present disclosure may provide information for weight estimation optimized according to a type of the vehicle, thus improving reliability of weight estimation.

The vehicle terminal 12 may receive and provide the information about the final weight estimation model and the extracted weight for each derived variable to the weight estimator 13.

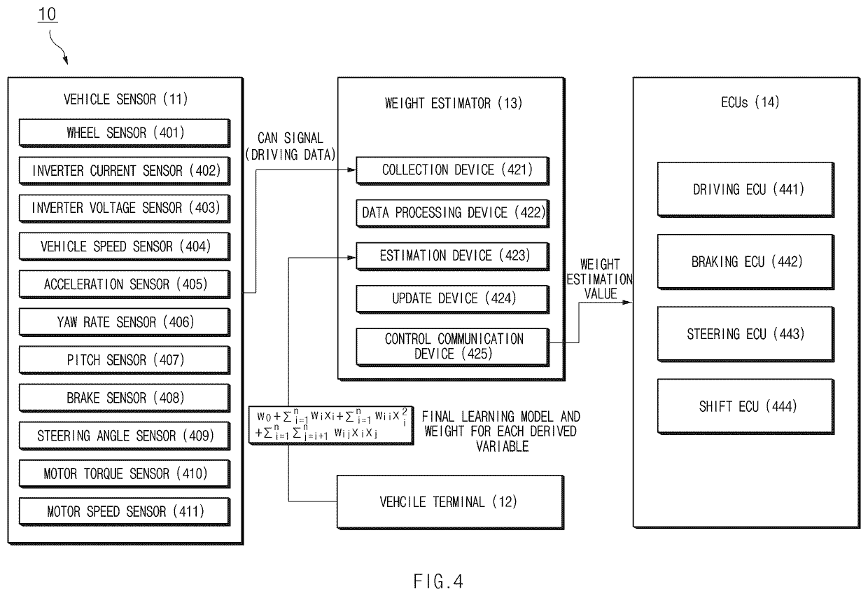

The vehicle sensor 11 may collect actual vehicle driving data using various sensors provided therein and may provide the weight estimator 13 with the collected actual vehicle driving data. The type of the vehicle sensor 11 will be clear via a description of FIG. 4, which will be described below.

As an example, the actual vehicle driving data may include, but is not limited to, wheel based speed data, lateral acceleration data, longitudinal acceleration data, yaw rate data, brake pedal position data, electric motor speed data, electric motor torque data, inverter current link data, inverter DC link voltage data, pinch angle data, steering wheel angle data, and the like.

The weight estimator 13 may generate a first-degree derived variable based on the actual vehicle driving data, that is, raw data, and may calculate a first-degree derived variable value.

The weight estimator 13 may extract average/quantile-based statistics based on the derived variable value and may calculate a second-degree derived variable based on the extracted statistics. Herein, the second-degree derived variable value may be applied to a dataset for weight estimation (hereinafter referred to as an “estimation dataset”). The estimation dataset according to an embodiment may be generated based on at least one of the first-degree derived variable value or the second-degree derived variable value.

The weight estimator 13 may construct weight estimation calculation logic based on the extracted weight for each derived variable.

The weight estimator 13 may apply the estimation dataset to the weight estimation calculation logic to estimate a weight of the commercial vehicle 10 corresponding to a current launch acceleration trip interval.

The weight estimator 13 may average a recently estimated weight value and previously estimated weight value(s) to compensate for error occurrence by a sensing error and noise of a gradient sensor, a steering wheel angle sensor, an acceleration sensor, or the like and may finally estimate the average weight value as a current weight. In other words, the weight estimator 13 may calculate a moving average for a weight estimation value to estimate a final weight, thus providing a weight estimation algorithm robust to the sensing error and the noise.

The weight estimator 13 may provide the ECUs 14 with information about the finally estimated weight.

The ECUs 14 may generate a control command depending on the recently updated weight and may control an operation of a driving and braking device.

As an example, the ECUs 14 may include a driving-related ECU and a braking-related ECU, but this is only an embodiment. The ECUs 14 may further include a steering ECU, a shift ECU, and the like depending on the design of those skilled in the art.

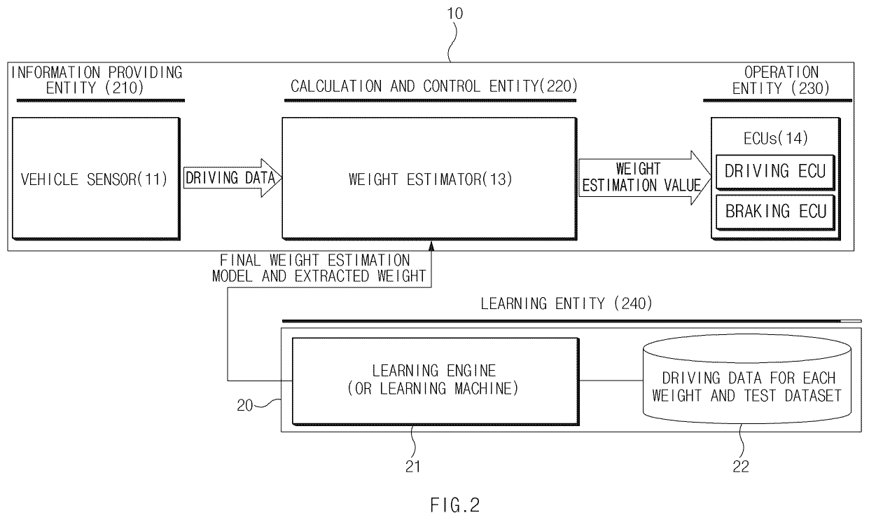

FIG. 2 is a drawing for describing control flow for each entity in a system for estimating a commercial vehicle weight according to an embodiment of the present disclosure.

Referring to FIG. 2, a commercial vehicle 10 may include an information providing entity 210, a calculation and control entity 220, and an operation entity 230 and, a cloud server 20 may include a learning entity 240.

The information providing entity 210 may provide the calculation and control entity 220 with actual vehicle driving data collected via a vehicle sensor 11. The calculation and control entity 220 may include a weight estimator 13 of FIG. 1. The weight estimator 13 may estimate a weight corresponding to a current launch acceleration trip interval and may provide the operation entity 230 with the estimated weight value. The operation entity 230 may include ECUs 14 of FIG. 1 and may control a driving and braking system based on the received weight estimation value.

The learning entity 240 may include a learning engine (or a learning machine) 21. The learning entity 240 may generate a weight estimation model via machine learning based on driving information data for each weight, which is stored in a database 22, and may apply a test dataset stored in the database 22 to the generated weight estimation model to verify performance.

The learning entity 240 may extract a weight for each derived variable from the weight estimation model, the verification of the performance of which is completed, that is, a final weight estimation model, and may provide the calculation and control entity 220 with information about the final weight estimation model and the extracted weight.

The calculation and control entity 220 may apply an estimation dataset generated based on actual vehicle driving data to weight estimation calculation logic constructed based on the weight to estimate a weight corresponding to a corresponding launch acceleration trip interval. At this time, the estimated weight may be updated using a moving average in a certain window interval and may be provided to the operation entity 230.

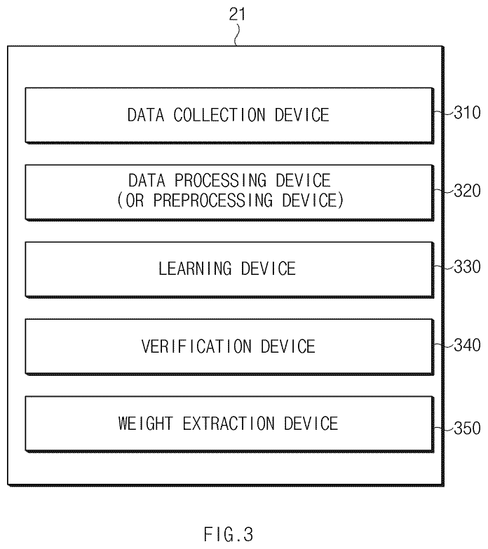

FIG. 3 is a block diagram for describing a configuration of a learning engine according to an embodiment of the present disclosure.

Referring to FIG. 3, a learning engine (or a learning machine) 21 may include a data collection device 310, a data processing device (or a preprocessing device) 320, a learning device 330, a verification device 340, and a weight extraction device 350.

The data collection device 310 may collect vehicle raw data for training. Herein, the vehicle raw data may be collected for each vehicle type and each weight and may include driving-related data collected from a vehicle sensor of a corresponding commercial vehicle.

The data processing device 320 may generate and calculate a first-degree derived variable for each weight based on driving data for each weight and may extract average/quantile-based statistics corresponding to the weight based on the first-degree derived variable value for each weight. The data processing device 320 may generate and calculate a second-degree derived variable for each weight based on the extracted statistics for each weight. The data processing device 320 may generate a training dataset based on the second-degree derived variable value for each weight.

The learning device 330 may perform learning based on the training dataset to generate a weight estimation model.

The verification device 340 may apply a previously constructed test dataset to the weight estimation model generated by the learning device 330 to verify performance for the weight estimation model. The verification device 340 may tune a learning model parameter depending on the result of verifying the performance and may fit a weight estimation model with performance of a certain reference value or less. Thereafter, the learning device 330 may perform retraining using the newly fitted weight estimation model. The retraining may be repeatedly performed until the current performance of the weight estimation model meets the certain reference value.

The weight estimation model according to an embodiment may be a multinomial regression model. A multinomial linear regression equation for each of variables for a driving weight, that is, a derived variable, according to a vehicle driving physical quantity may be generated via a tuning optimization process of the multinomial regression model.

The weight extraction device 350 may extract a weight based on the multinomial linear regression equation for each derived variable based on the weight estimation model, the verification of the performance of which is completed, that is, a final weight estimation model.

FIG. 4 is a block diagram for describing a detailed structure of a commercial vehicle 10 according to an embodiment of the present disclosure.

Referring to FIG. 4, the commercial vehicle 10 may be configured to include a vehicle sensor 11, a vehicle terminal 12, a weight estimator 13, and ECUs 14.

The vehicle sensor 11 may include at least one of a wheel sensor 401 for measuring a wheel-based speed, an inverter current sensor 402 for measuring a current applied to an inverter, an inverter voltage sensor 403 for measuring a DC voltage applied to the inverter, a vehicle speed sensor 404 for measuring a vehicle speed, an acceleration sensor 405 for measuring acceleration of the vehicle, a yaw rate sensor 406 for measuring a yaw rate, a pitch sensor 407 for measuring pitch, a brake sensor 408 for measuring brake pressure or a brake position, a steering angle sensor 409 for measuring a steering angle of a steering wheel, a motor torque sensor 410 for measuring power of an electric motor, or a motor speed sensor 411 for measuring a rotational speed of the electric motor.

The vehicle sensor 11 may transmit real-time vehicle driving data sensed by sensors provided therein to the weight estimator 13 via CAN communication.

The weight estimator 13 may include a collection device 421, a data processing device 422, an estimation device 423, an update device 424, and a control communication device 425.

The collection device 421 may collect real-time vehicle driving data via CAN communication from the vehicle sensor 11.

The data processing device 422 may generate an estimation dataset for weight estimation.

The data processing device 422 may identify a launch acceleration trip interval based on the real-time vehicle driving data and may generate a first-degree derived variable corresponding to the identified launch acceleration trip interval. The data processing device 422 may calculate the generated first-degree derived variable value.

The data processing device 422 may extract average or quantile-based statistics based on the first-degree derived variable value and may calculate a second-degree derived variable value based on the extracted statistics.

The data processing device 422 may generate an estimation dataset based on the second-degree derived variable value.

The vehicle terminal 12 may receive information about a final learning model and a weight for each derived variable from a cloud server 20 and may provide the weight estimator 13 with the received information.

The estimation device 423 may construct weight estimation calculation logic based on the weight for each derived variable, which is received from the vehicle terminal 12, and may apply the estimation dataset to the weight estimation calculation logic to estimate a weight corresponding to the launch acceleration trip interval.

The update device 424 may calculate a moving average of a weight estimation value corresponding to a certain window interval and may calculate a final weight estimation value corresponding to the launch acceleration trip interval.

The control collection device 425 may transmit the final weight estimation value to the ECUs 14. As an example, the control communication device 425 may transmit the final weight estimation value to the ECUs 14 via CAN communication.

The ECUs 14 may include at least one of a driving ECU 441, a braking ECU 442, a steering ECU 443, or a shift ECU 444.

The ECUs 14 may control at least one of driving, braking, steering, or shift based on the final weight estimation value received from the weight estimator 13.

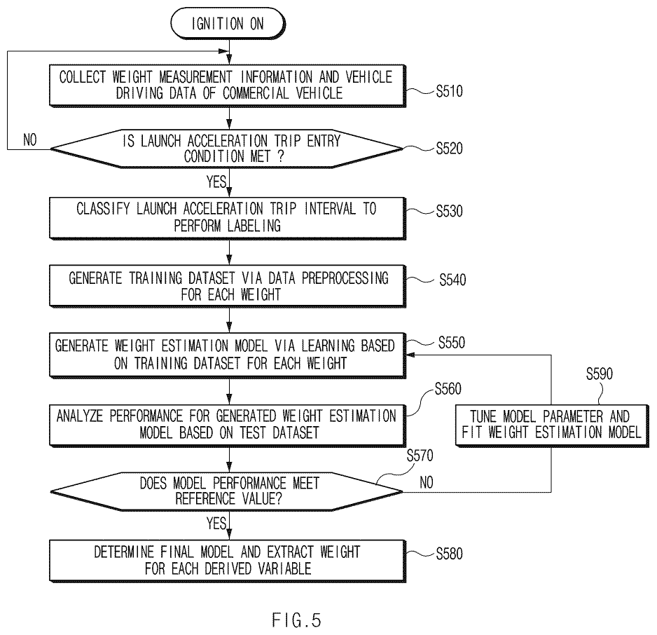

FIG. 5 is a flowchart for describing a method for generating a model for weight estimation in a learning machine according to an embodiment of the present disclosure.

In S510, a learning machine 21 may collect weight measurement information and vehicle driving data of a commercial vehicle 10. Herein, the weight measurement information and the vehicle driving data may be collected at a certain period from at least one vehicle for each of a plurality of different vehicle types (or vehicle models) which are ignition on. The learning machine 21 may classify vehicle driving data for each weight according to a vehicle type.

In S520, the learning machine 21 may compare the vehicle driving data for each weight with a predefined initial ACC condition to determine whether a launch acceleration trip entry condition is met.

If the launch acceleration trip entry condition is met, in S530, the learning machine 21 may classify a corresponding launch acceleration trip interval to perform labeling.

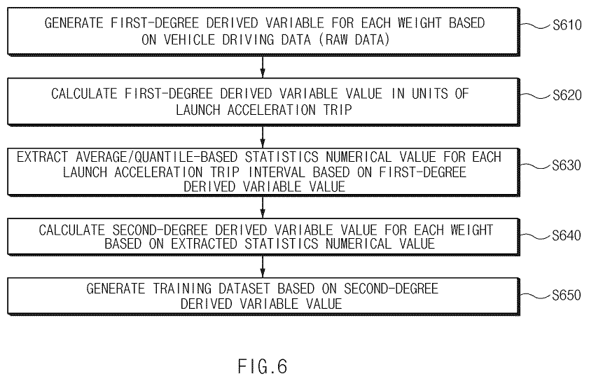

In S540, the learning machine 21 may generate a training dataset via data preprocessing for each weight. Herein, the process of generating the training dataset, that is, the data preprocessing process will be described in detail below with reference to FIG. 6 which will be described below.

In S550, the learning machine 21 may generate a weight estimation model via learning based on the training dataset for each weight.

In S560, the learning machine 21 may analyze performance for the generated weight estimation model based on a test dataset.

In S570, the learning machine 21 may determine whether current model performance meets a certain reference value.

If the reference value is met as a result of the determination, in S580, the learning machine 21 may determine the current weight estimation model as a final weight estimation model and may extract a weight for each derived variable based on the determined final weight estimation model. Herein, information about the final weight estimation model and the extracted weight for each derived variable may be transmitted to a corresponding vehicle type of commercial vehicle.

If the current performance of the weight estimation model does not meet the reference value as a result of the determination in S570, in S590, the learning machine 21 may tune a model parameter and may fit the weight estimation model. At this time, the learning machine 21 may perform retraining using the fitted weight estimation model.

FIG. 6 is a flowchart for describing a preprocessing method in a learning machine according to an embodiment of the present disclosure.

Referring to FIG. 6, in S610, a learning machine 21 may generate a first-degree derived variable for each weight based on vehicle driving data, that is, raw data.

In S620, the learning machine 21 may calculate a first-degree derived variable value in units of a previously classified launch acceleration trip.

In S630, the learning machine 21 may extract an average/quantile-based statistics numerical value for each launch acceleration trip interval based on the first-degree derived variable value.

In S640, the learning machine 21 may calculate a second-degree derived variable value for each weight based on the extracted statistics numerical value.

In S650, the learning machine 21 may generate a training dataset based on the second-degree derived variable value.

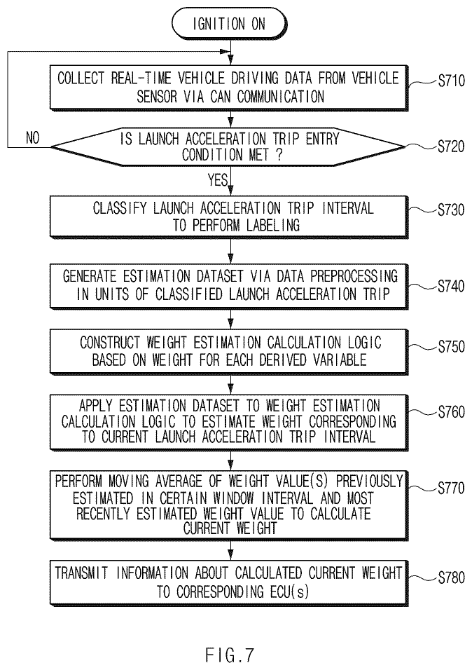

FIG. 7 is a flowchart for describing a method for estimating a weight in a weight estimator according to an embodiment of the present disclosure.

Referring to FIG. 7, if a commercial vehicle 10 is ignition on, in S710, a weight estimator 13 may collect real-time vehicle driving data from a vehicle sensor 11 via CAN communication.

In S720, the weight estimator 13 may compare the vehicle driving data with a predefined initial ACC condition to determine whether a launch acceleration trip entry condition is met.

If the launch acceleration trip entry condition is met, in S730, the weight estimator 13 may classify a corresponding launch acceleration trip interval to perform labeling.

In S740, the weight estimator 13 may generate an estimation dataset via data preprocessing in units of the classified launch acceleration trip. Herein, the data preprocessing procedure may be performed to be similar to the data preprocessing method of FIG. 6, which is described above. However, it should be noted that the data preprocessing by the weight estimator 13 is not performed for each weight and is performed for vehicle driving data corresponding to the classified launch acceleration trip interval.

In S750, the weight estimator 13 may construct weight estimation calculation logic based on a weight for each derived variable extracted by a learning machine 21.

In S760, the weight estimator 13 may apply an estimation dataset to the weight estimation calculation logic to estimate a weight corresponding to the current launch acceleration trip interval.

In S770, the weight estimator 13 may perform a moving average of weight value(s) previously estimated in a certain window interval and a most recently estimated weight value to calculate a current weight.

In S780, the weight estimator 13 may transmit information about the calculated current weight to corresponding ECU(s). Herein, the ECU may include, but is not limited to, a driving-related ECU and a braking-related ECU. The ECU(s) may perform a control operation for optimizing a driving and braking system based on the current weight.

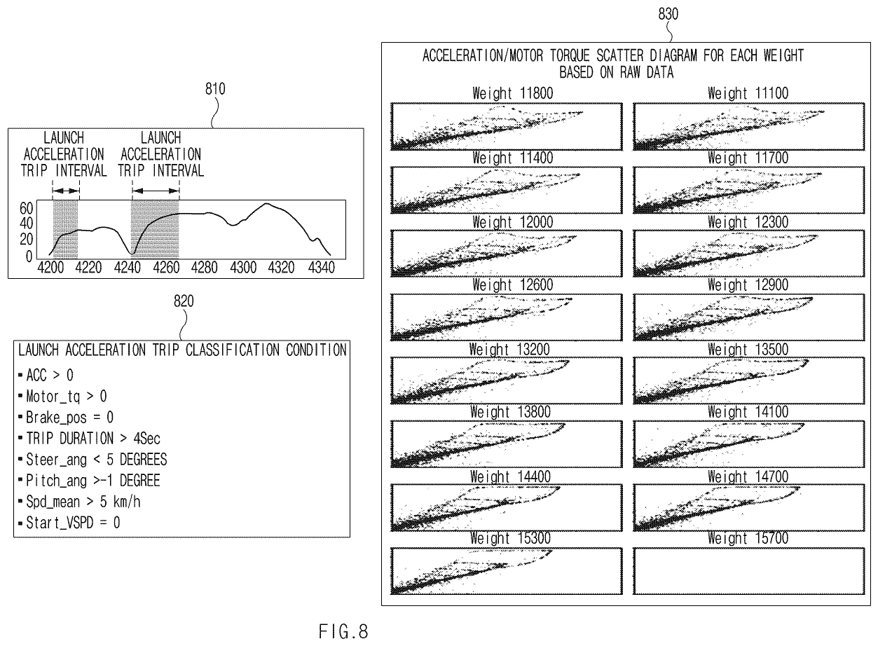

FIG. 8 illustrates an example of applying a launch acceleration trip-based derived variable according to an embodiment of the present disclosure.

In detail, FIG. 8 illustrates an example of classifying a launch acceleration trip based on previously collected vehicle driving data, that is, raw data and generating and applying a derived variable capable of specifying a relationship between acceleration for each weight and motor torque for the classified launch acceleration trip interval.

A learning machine 21 and a weight estimator 13 may classify (or classify) a launch acceleration trip interval based on a predefined launch acceleration trip classification condition 820.

As an example, the launch acceleration trip classification condition 820 may include at least one of a condition in which the accessory (ACC) is greater than 0, that is, ON mode, a condition in which motor torque Motor_tq is greater than 0, a condition in which a brake position (or pressure) Brake_pos is greater than 0, a condition in which a trip duration is greater than or equal to 4 seconds, a condition in which an angle Steer_ang of a steering wheel is greater than 5 degrees, a condition in which a pitch angle Pitch_ang is greater than-1 degree, a condition in which a means speed Spd_mean is greater than 5 km/h, or a condition in which a start speed Start_VSPD is 0. If the launch acceleration trip classification condition 820 is satisfied, as shown in reference numeral 810, the learning machine 21 may determine that a corresponding vehicle enters a launch acceleration trip interval.

As an example, because the learning machine 21 and the weight estimator 13 perform weight estimation and an update in a condition in which the vehicle accelerates during 4 seconds or more in a state in which the vehicle is stopped, that is, a state in which a vehicle speed (VS) is 0, they may optimize performance of a driving and braking system in adaptive response to a frequent change in weight of a commercial vehicle, such as a bus.

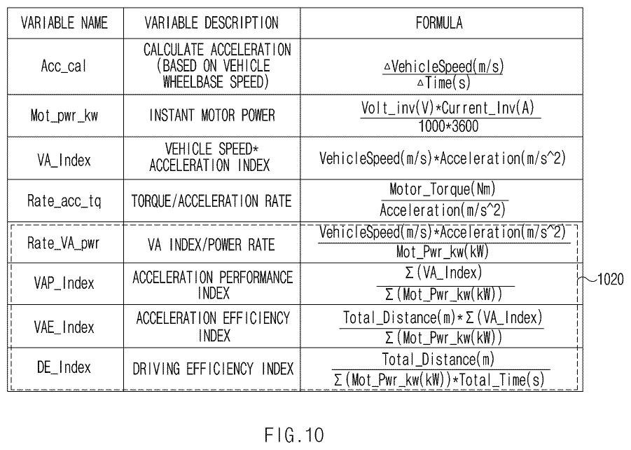

As shown in reference numeral 830, the learning machine 21 and the weight estimator 13 may generate a derived variable indicating a relationship between acceleration data for each weight and motor torque data in response to the classified launch acceleration trip interval. In other words, the learning machine 21 may generate a first-degree derived variable indicating an acceleration/motor torque relationship for each weight, for example, a torque/acceleration rate Rate_acc_tq of FIG. 10 which will be described below, based on raw data.

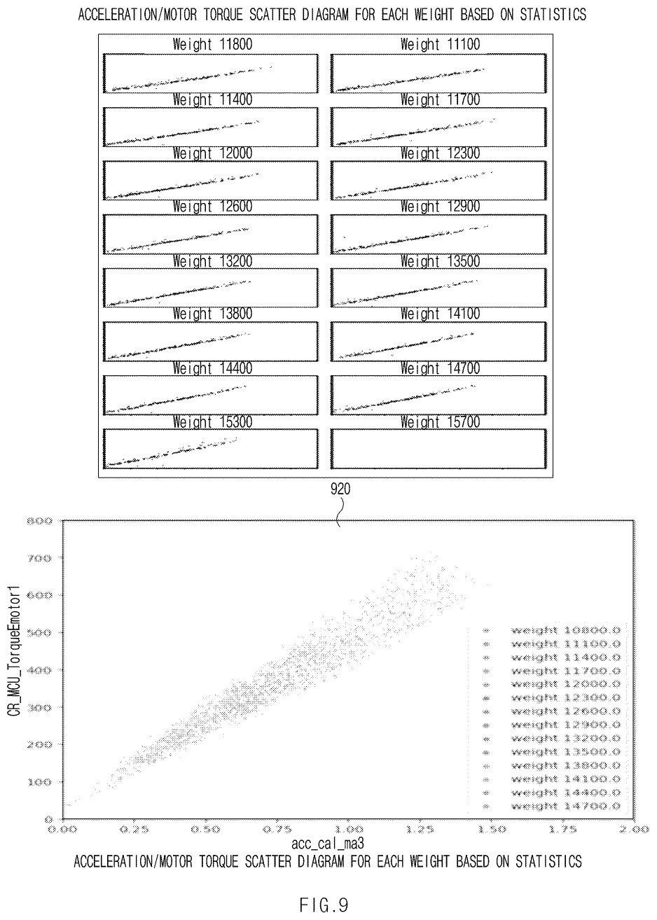

FIG. 9 illustrates an example of applying a derived variable based on statistics according to an embodiment of the present disclosure.

As shown in reference numeral 910, a statistics numerical value for each weight may be extracted based on a derived variable for each weight based on raw data generated in FIG. 8, that is, a first-degree derived variable. Reference numeral 920 is an analysis graph illustrating an acceleration/motor torque relationship for each weight based on statistics in units of a launch acceleration trip.

A method for estimating a commercial vehicle weight according to the present disclosure may be to generate a derived variable indicating a relationship between variables based on raw data collected from a vehicle sensor and extract statistics corresponding to the generated derived variable to generate a dataset to reflect a physical relationship between pieces of dynamic data of the vehicle in a weight estimation model, thus considerably improving reliability and accuracy of the weight estimation model.

FIG. 10 is a table in which a derived variable and an operational formula thereof are defined.

Referring to FIG. 10, the derived variable may include at least one of vehicle wheelbase speed-based acceleration Acc_cal, instant motor power Mot_pwr_kw, a vehicle speed*acceleration index VA_index, a torque/acceleration rate Rate_acc_tq, a VA index/power rate Rate_VA_pwr, an acceleration performance index VAP_Index, an acceleration efficiency index VAE_Index, or a driving efficiency index DE_Index.

As shown in reference numeral 1010, some derived variables may be defined based on another derived variable. As an example, the VA index/power rate Rate_VA_pwr, the acceleration performance index VAP_Index, the acceleration efficiency index VAE_Index, and the driving efficiency index DE_Index may be calculated based on the instant motor power Mot_pwr_kw.

Driving data collected from a vehicle sensor 11 may be a single variable, which is time-series data in which a physical quantity is excluded.

A weight estimator 13 according to the present disclosure may extract derived variable-based trip statistics using a predefined derived variable capable of specifying a relationship between a dynamic state of a vehicle and an output-related variable of a motor to reflect a physical relationship for the dynamic state of the vehicle upon weight estimation, thus improving reliability and accuracy of a weight estimation model.

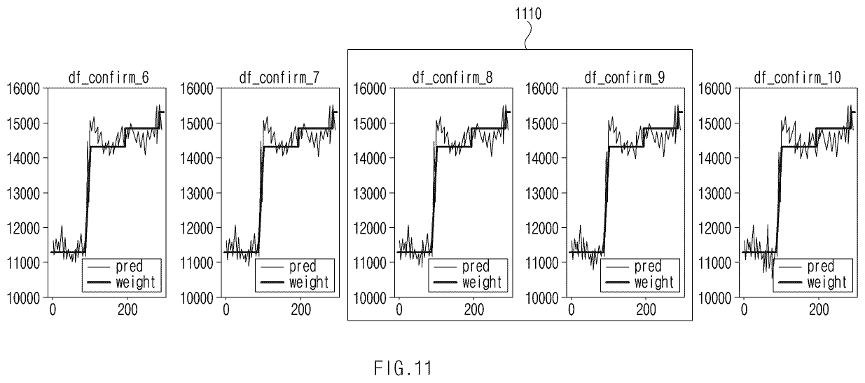

FIG. 11 is a drawing for describing a method for extracting average or quantile data for each trip according to an embodiment of the present disclosure.

Referring to FIG. 11, to minimize an average error if extracting statistics of derived variables and increase model performance, as shown in reference numeral 1110, a weight estimator 13 according to the present disclosure may extract a statistics numerical value corresponding to 0.8 and 0.9 with respect to quantile and may add the statistics numerical value to a dataset to measure the central tendency better than the average even if a singular value is included in the dataset, thus improving accuracy of weight estimation.

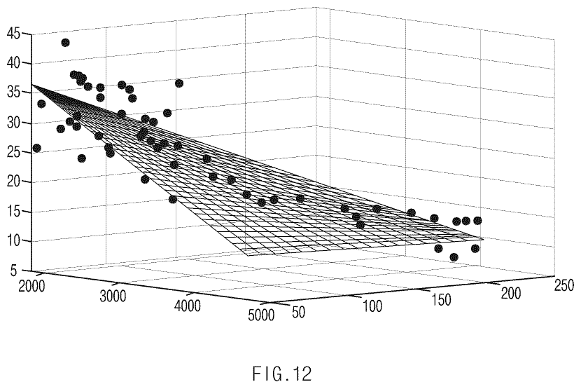

FIG. 12 is a drawing for describing a multinomial linear regression model which is a machine learning model according to an embodiment of the present disclosure.

If weight estimation logic should be embedded in a vehicle, a computing resource should be considered.

A multinomial regression technique applied to the present disclosure is one of regression analysis techniques for modeling a linear relationship between a multi-dimensional input variable X and an output variable y, which is used to generate a model for predicting an output value, that is, a weight, via a linear function for a given input value.

Furthermore, the multinomial regression technique facilitates Nth-degree curve prediction for training data using least squares or the like and facilitates model reconstruction based on an extracted weight for each derived variable. As an example, a second-degree polynomial features (polynomial features degree=2) may be applied, but this is only one embodiment. Polynomial features greater than the second degree may be applied according to the design of those skilled in the art. Herein, a regression model modeled with a second-degree polynomial may generate a second-degree feature, that is, a derived variable, via multiplication of an original feature and may convert data to intrinsically include a second-degree term together with a linear term. In other words, a second-degree multinomial linear regression model according to the present disclosure is the result of defining a derived variable capable of specifying a physical relationship between two physical quantities based on physical quantities generated in a dynamic state of a vehicle, for example, motor torque and vehicle acceleration, and mathematically modeling an associated characteristic between the derived variable and the weight. At this time, a degree to which it contributes to a weight for each derived variable may be estimated via learning and this may be defined as a weight of the derived variable.

A weight estimator 13 according to the present disclosure may construct weight estimation calculation logic based on a weight for each derived variable extracted via pre-training, thus estimating a vehicle weight in a current launch acceleration interval using small computing resources.

The present disclosure may minimize the use of computing resources upon weight estimation, thus reducing manufacturing cost of a commercial vehicle.

It is described that the learning engine (or the learning machine) is implemented in the cloud server in FIGS. 1 to 12, but this is only an embodiment. A learning engine (or a learning machine) according to another embodiment of the present disclosure may be implemented in a commercial vehicle. If the learning engine (or the learning machine) is implemented in the commercial vehicle, the learning machine may be implemented to generate only a weight estimation model corresponding to the commercial vehicle.

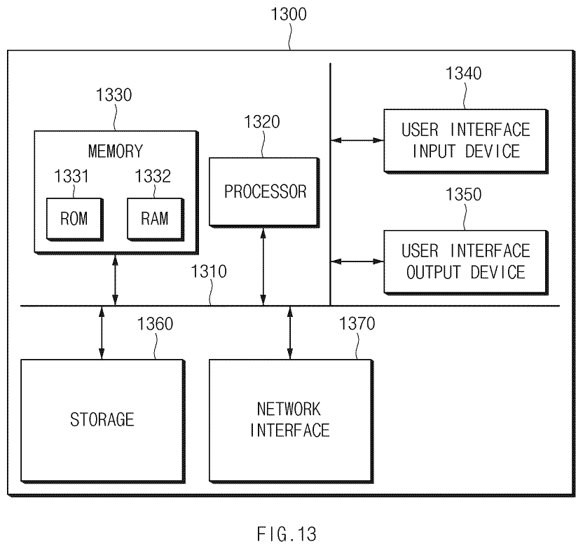

FIG. 13 illustrates a computing system according to an embodiment of the present disclosure.

Referring to FIG. 13, a computing system 1300 may include at least one processor 1320, a memory 1330, a user interface input device 1340, a user interface output device 1350, a storage 1360, and a network interface 1370, which are connected with each other via a bus 1310.

The processor 1320 may be a central processing unit (CPU) or a semiconductor device that processes instructions stored in the memory 1330 and/or the storage 1360. The memory 1330 and the storage 1360 may include various types of volatile or non-volatile storage media. For example, the memory 1330 may include a ROM (Read Only Memory) 1331 and a RAM (Random Access Memory) 1332.

Thus, the operations of the method or the algorithm described in connection with the embodiments disclosed herein may be embodied directly in hardware or a software module executed by the processor 1320, or in a combination thereof. The software module may reside on a storage medium (that is, the memory 1330 and/or the storage 1360) such as a RAM, a flash memory, a ROM, an EPROM, an EEPROM, a register, a hard disc, a removable disk, and a CD-ROM. As an example, the processor 1320 may be mounted on at least one of the commercial vehicle 10 and the cloud server 20, which are described above.

The exemplary storage medium may be coupled to the processor 1320. The processor 1320 may read out information from the storage medium and may write information in the storage medium. Alternatively, the storage medium may be integrated with the processor 1320. The processor 1320 and storage medium may be implemented with an application specific integrated circuit (ASIC). The ASIC may reside in the control unit in the vehicle. Alternatively, the processor 1320 and storage medium may reside as separate components in the vehicle control unit.

The present technology may provide the method for estimating the commercial vehicle weight based on the driving data and the apparatus therefor.

Furthermore, the present technology may provide the method for estimating the commercial vehicle weight based on the driving data to generate a weight estimation model via derived variable learning capable of using commercial vehicle characteristics and specifying a physical relationship to minimize a computing resource of a controller and improve an inference speed and the apparatus therefor.

Furthermore, the present technology may provide the method for estimating the commercial vehicle weight based on the driving data to estimate the weight of the commercial vehicle via a machine learning model with small complexity and the apparatus therefor.

Furthermore, the present technology may provide the weight estimation learning algorithm for applying a statistics-based training dataset using a derived variable capable of following a physical relationship and an associated characteristic between driving data and a weight to a model to provide a weight estimation model with larger reliability and the apparatus therefor.

Furthermore, the present technology may reconstruct a multinomial linear regression equation for each derived variable based on a weight of a pre-trained model to estimate a weight and may apply moving average for the estimated weight value to update a current weight, thus facilitating more accurate weight estimation for the commercial vehicle.

Furthermore, the present technology may apply the estimated weight to control logic of the vehicle to ensure vehicle control robustness and reliability, thus improving marketability for the driving and braking system.

Furthermore, the present technology may apply a derived variable-based driving physical quantity to a model to train the model and may estimate a weight using the trained model, thus improving the accuracy of estimation for a driving condition which is not learned.

Furthermore, the present technology may apply a weight-based calculation method for each derived variable to considerably reduce controller resource consumption compared to a conventional deep learning/machine learning model with large complexity, thus facilitating VCU embedding.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Accordingly, embodiments of the present disclosure are intended not to limit but to explain the technical idea of the present disclosure, and the scope and spirit of the invention is not limited by the above embodiments. The scope of the present disclosure should be construed on the basis of the accompanying claims, and all the technical ideas within the scope equivalent to the claims should be included in the scope of the present disclosure.

1. A computing device provided in a commercial vehicle, the computing device comprising:
a processor configured to execute instructions; and
a memory storing the instructions,
wherein the processor is configured to:
collect real-time vehicle driving data based on an ignition on state of the commercial vehicle;
compare the real-time vehicle driving data with a certain launch acceleration trip condition to identify a launch acceleration trip interval;
perform data preprocessing for the identified launch acceleration trip interval to generate an estimation dataset; and
apply the estimation dataset to weight estimation calculation logic to estimate a weight corresponding to the identified launch acceleration trip interval.

2. The computing device of claim 1, wherein the processor is configured to:
calculate a first-degree derived variable value based on the real-time vehicle driving data;
extract an average and quantile-based statistics numerical value based on the first-degree derived variable value;
calculate a second-degree derived variable value based on the statistics numerical value; and generate the estimation dataset based on the second-degree derived variable value.

3. The computing device of claim 2, wherein a first-degree derived variable is a variable capable of following a correlation between at least two physical quantities included in the real-time vehicle driving data and the weight.

4. The computing device of claim 3, wherein the processor is configured to:
construct the weight estimation calculation logic based on a weight for each first-degree derived variable extracted from a pre-trained final weight estimation model.

5. The computing device of claim 4, wherein the processor is configured to:
collect vehicle driving data for each weight corresponding to the commercial vehicle;
preprocess the vehicle driving data for each weight to generate a training dataset for each weight;
perform machine learning based on the training dataset for each weight to generate a weight estimation model; and
verify performance for the weight estimation model based on a previously constructed test dataset to determine the final weight estimation model.

6. The computing device of claim 5, wherein the processor is configured to:
calculate a first-degree derived variable value for each weight based on the vehicle driving data for each weight;
extract an average and quantile-based statistics numerical value for each weight based on the first-degree derived variable value for each weight;
calculate a second-degree derived variable value for each weight based on the statistics numerical value for each weight; and
generate the training dataset for each weight based on at least one of the first-degree derived variable value for each weight or the second-degree derived variable value for each weight.

7. The computing device of claim 1, wherein the processor is configured to:
perform a moving average of at least one weight previously estimated in a certain window interval and the estimated weight to update the estimated weight in response to the identified launch acceleration trip interval.

8. The computing device of claim 7, wherein the processor is configured to:
provide a driving and braking system provided in the commercial vehicle with information about the updated weight.

9. The computing device of claim 1, wherein the real-time vehicle driving data includes at least one of wheel based speed data, lateral acceleration data, longitudinal acceleration data, yaw rate data, brake pedal position data, electric motor speed data, electric motor torque data, inverter current link data, inverter DC link voltage data, pinch angle data, or steering wheel angle data.

10. The computing device of claim 2, wherein a first-degree derived variable includes at least one of vehicle wheelbase speed-based acceleration Acc_cal, instant motor power Mot_pwr_kw, a vehicle speed*acceleration index VA_index, a torque/acceleration rate Rate_acc_tq, a VA index/power rate Rate_VA_pwr, an acceleration performance index VAP_Index, an acceleration efficiency index VAE_Index, or a driving efficiency index DE_Index.

11. A method for estimating a weight in a commercial vehicle, the method comprising:
collecting real-time vehicle driving data based on an ignition on state of the commercial vehicle;
comparing the real-time vehicle driving data with a certain launch acceleration trip condition to identify a launch acceleration trip interval;
performing data preprocessing for the identified launch acceleration trip interval to generate an estimation dataset; and
applying the estimation dataset to weight estimation calculation logic to estimate a weight corresponding to the identified launch acceleration trip interval.

12. The method of claim 11, wherein the performing of the data preprocessing to generate the estimation dataset includes:
calculating a first-degree derived variable value based on the real-time vehicle driving data;
extracting an average and quantile-based statistics numerical value based on the first-degree derived variable value; and
calculating a second-degree derived variable value based on the statistics numerical value,
wherein the estimation dataset is generated based on the second-degree derived variable value.

13. The method of claim 12, wherein a first-degree derived variable is a variable capable of following a correlation between at least two physical quantities included in the real-time vehicle driving data and the weight.

14. The method of claim 13, wherein the weight estimation calculation logic is constructed based on a weight for each first-degree derived variable extracted from a pre-trained final weight estimation model.

15. The method of claim 14, wherein the final weight estimation model is generated via a learning process including:
collecting vehicle driving data for each weight corresponding to a vehicle type of the commercial vehicle;
preprocessing the vehicle driving data for each weight to generate a training dataset for each weight;
performing machine learning based on the training dataset for each weight to generate a weight estimation model; and
verifying performance for the weight estimation model based on a previously constructed test dataset to determine the final weight estimation model.

16. The method of claim 15, wherein the preprocessing of the vehicle driving data for each weight to generate the training dataset for each weight includes:
calculating a first-degree derived variable value for each weight based on the vehicle driving data for each weight;
extracting an average and quantile-based statistics numerical value for each weight based on the first-degree derived variable value for each weight; and
calculating a second-degree derived variable value for each weight based on the statistics numerical value for each weight,
wherein the training dataset for each weight is generated based on at least one of the first-degree derived variable value for each weight or the second-degree derived variable value for each weight.

17. The method of claim 1, further comprising:
performing a moving average of at least one weight previously estimated in a certain window interval and the estimated weight to update the estimated weight in response to the identified launch acceleration trip interval.

18. The method of claim 17, further comprising:
transmitting information about the updated weight to a driving and braking system provided in the commercial vehicle.

19. The method of claim 11, wherein the real-time vehicle driving data includes at least one of wheel based speed data, lateral acceleration data, longitudinal acceleration data, yaw rate data, brake pedal position data, electric motor speed data, electric motor torque data, inverter current link data, inverter DC link voltage data, pinch angle data, and steering wheel angle data.

20. The method of claim 12, wherein a first-degree derived variable includes at least one of vehicle wheelbase speed-based acceleration Acc_cal, instant motor power Mot_pwr_kw, a vehicle speed*acceleration index VA_index, a torque/acceleration rate Rate_acc_tq, a VA index/power rate Rate_VA_pwr, an acceleration performance index VAP_Index, an acceleration efficiency index VAE_Index, and a driving efficiency index DE_Index.
